(19) United States
(12) Patent Application Publication
(10) Pub. No.: US 2026/0235357 A1
(43) Pub. Date: Aug. 13, 2026

(54) STORAGE DEVICE

(71) Applicant: TAIYO NIPPON SANSO CORPORATION, Shinagawa-ku, Tokyo (JP)

(72) Inventors: Takashi KAMEOKA, Shinagawa-ku, Tokyo (JP); Ryoma WATANABE, Shinagawa-ku, Tokyo (JP); Yosuke MUKAI, Shinagawa-ku, Tokyo (JP); Sota KAGAWA, Shinagawa-ku, Tokyo (JP)

(73) Assignee: TAIYO NIPPON SANSO CORPORATION, Shinagawa-ku, Tokyo (JP)

(21) Appl. No.: 19/154,769

(22) PCT Filed: Nov. 2, 2023
(86) PCT No.: PCT/JP2023/039666

§ 371 Date: Aug. 7, 2025

(30) Foreign Application Priority Data
Mar. 24, 2023 (JP) 2023-049037

(51) Int. Cl. F26B 3/04; B08B 9/08; C11D 7/26

(52) U.S. Cl. CPC F26B 3/04; B08B 9/08; C11D 7/265; B08B 2209/08

(57) ABSTRACT

A storage device includes a storage tank configured to store a liquid or solid storage material, a solvent tank configured to store a solvent, a channel section that can supply an inert gas to the solvent tank, can discharge gas from the storage tank, can supply the solvent from the solvent tank to the storage tank by supplying the inert gas to the solvent tank and discharging gas from the storage tank, can supply an inert gas to the storage tank, and can discharge the solvent from the storage tank by supplying the inert gas to the storage tank, and a detector configured to detect the storage material in the solvent supplied to the storage tank.

### TECHNICAL FIELD

The present disclosure relates to a storage device.

### BACKGROUND

Devices for cleaning storage tanks are known. See, for example, Patent Literature (PTL) 1.

### CITATION LIST

### Patent Literature

PTL 1: JP 3381925 B2

### SUMMARY

### Technical Problem

A storage device having a storage tank for storing a liquid or solid storage material is preferably capable of precisely removing residues of the storage material remaining in the storage tank after use, in order to repeatedly use the storage tank while suppressing contamination by impurities and maintaining high purity of the storage material.

The present disclosure thus aims to provide a storage device that can precisely remove residues from a storage tank.

### Solution to Problem

One aspect of the present disclosure is as follows.
[1] A storage device comprising:
a storage tank configured to store a liquid or solid storage material;
a solvent tank configured to store a solvent;
a channel section that can supply an inert gas to the solvent tank, can discharge gas from the storage tank, can supply the solvent from the solvent tank to the storage tank by supplying the inert gas to the solvent tank and discharging gas from the storage tank, can supply an inert gas to the storage tank, and can discharge the solvent from the storage tank by supplying the inert gas to the storage tank; and a detector configured to detect the storage material in the solvent supplied to the storage tank.
[2] The storage device according to [1], further comprising
an acid/alkaline solution tank configured to store an acid/alkaline solution that is an acidic or alkaline solution, wherein
the channel section can supply an inert gas to the acid/alkaline solution tank, can supply the acid/alkaline solution from the acid/alkaline solution tank to the storage tank by supplying the inert gas to the acid/alkaline solution tank and discharging gas from the storage tank, and can discharge the acid/alkaline solution from the storage tank by supplying an inert gas to the storage tank.
[3] The storage device according to [2], wherein the channel section can supply an inert gas into the acid/alkaline solution inside the storage tank.
[4] The storage device according to [2] or [3], wherein the acid/alkaline solution is an acidic solution containing nitric acid, citric acid, or hydrofluoric acid, or an alkaline solution containing ammonia water.
[5] The storage device according to any one of [2] to [4], further comprising
a reuse tank configured to store the acid/alkaline solution, wherein
the channel section can discharge gas from the reuse tank, can supply the acid/alkaline solution from the storage tank to the reuse tank by supplying an inert gas to the storage tank and discharging gas from the reuse tank, and can supply the acid/alkaline solution from the reuse tank to the storage tank by supplying an inert gas to the reuse tank and discharging gas from the storage tank.

The storage device according to any one of [1] to [5], wherein the channel section can supply deionized water to the storage tank and can discharge the deionized water from the storage tank.
[7] The storage device according to [6], wherein the channel section can circulate the deionized water to the storage tank.
[8] The storage device according to any one of [1] to [7], further comprising a heater configured to heat the storage tank, wherein the channel section can dry the storage tank by supplying an inert gas to the storage tank after a temperature of the storage tank has been raised by the heater.
[9] The storage device according to any one of [1] to [8], wherein the storage material is an organic or inorganic metal compound that is in a liquid or solid state at 25° C. and 1 atmosphere.
[10] The storage device according to any one of [1] to [9], wherein the solvent is an organic compound.
[11] The storage device according to any one of [1] to [10], wherein the detector is configured by a pH meter, a spectrometer, a colorimeter, an ultrasonic meter, or a mass spectrometer.

### Advantageous Effect

According to the present disclosure, it is possible to provide a storage device that can precisely remove residues from a storage tank.

### BRIEF DESCRIPTION OF THE DRAWINGS

In the accompanying drawings:

FIG. 1 is a schematic diagram illustrating an example of piping in a storage device of a first embodiment of the present disclosure;

FIG. 2 is a schematic diagram illustrating an example of piping in a storage device of a second embodiment of the present disclosure;

FIG. 3 is a schematic diagram illustrating an example of piping in a storage device of a third embodiment of the present disclosure;

FIG. 4 is a schematic diagram illustrating an example of piping in a storage device of a fourth embodiment of the present disclosure; and

FIG. 5 is a diagram for describing a storage device of a fifth embodiment of the present disclosure.

### DETAILED DESCRIPTION

Hereinafter, embodiments of the present disclosure will be illustrated with reference to the drawings.

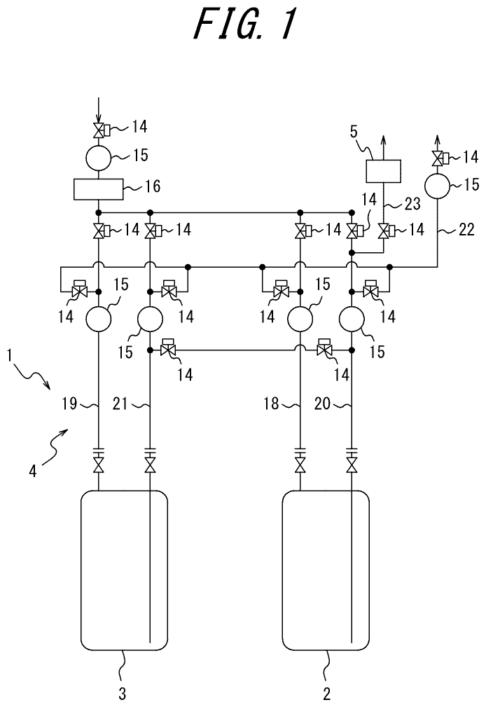

As illustrated in FIG. 1, in a first embodiment of the present disclosure, a storage device 1 includes a storage tank 2 that stores a liquid or solid storage material, a solvent tank 3 that stores a solvent, a channel section 4 that can supply an inert gas to the solvent tank 3, can discharge gas from the storage tank 2, can supply the solvent from the solvent tank 3 to the storage tank 2 by supplying the inert gas to the solvent tank 3 and discharging gas from the storage tank 2, can supply an inert gas to the storage tank 2, and can discharge the solvent from the storage tank 2 by supplying the inert gas to the storage tank 2, and a detector 5 that detects the storage material in the solvent supplied to the storage tank 2.

According to the above configuration, a solvent treatment process can be performed wherein an inert gas is supplied to the solvent tank 3 (for example, pressurized at 0.1 MPaG or more) and gas is discharged from the storage tank 2, thereby supplying solvent from the solvent tank 3 to the storage tank 2 and dissolving the residue of the storage material remaining in the storage tank 2 into the solvent, and wherein inert gas is supplied to the storage tank 2 (for example, pressurized at 0.1 MPaG or more), thereby discharging the solvent from the storage tank 2. In addition, the solvent treatment process can be repeated until the residue in the storage tank 2 is sufficiently reduced. At that time, by detecting the storage material in the solvent supplied to the storage tank 2 with the detector 5, it is possible to determine, for example by comparing the detected value with a threshold, whether the removal of the residue in the storage tank 2 by the solvent is sufficient to terminate the repetition of the solvent treatment process. Therefore, according to the above configuration, it is possible to realize a storage device 1 that can precisely remove the residue in the storage tank 2.

Also, according to the above configuration, it is possible to process the residue using an inert gas and a solvent, while suppressing contact with air and moisture. Therefore, it is particularly effective when the storage material is water-reactive and/or corrosive. The storage material is, for example, a film-forming material in a semiconductor process. The channel section 4 is, for example, formed by sealed piping. The solvent treatment process can be performed after the storage material discharge process, which supplies inert gas to the storage tank (for example, pressurized at 0.1 MPaG or more) and discharges the storage material from the storage tank via the channel section 4. The detector 5 can, for example, be provided on the channel for discharging the solvent from the storage tank.

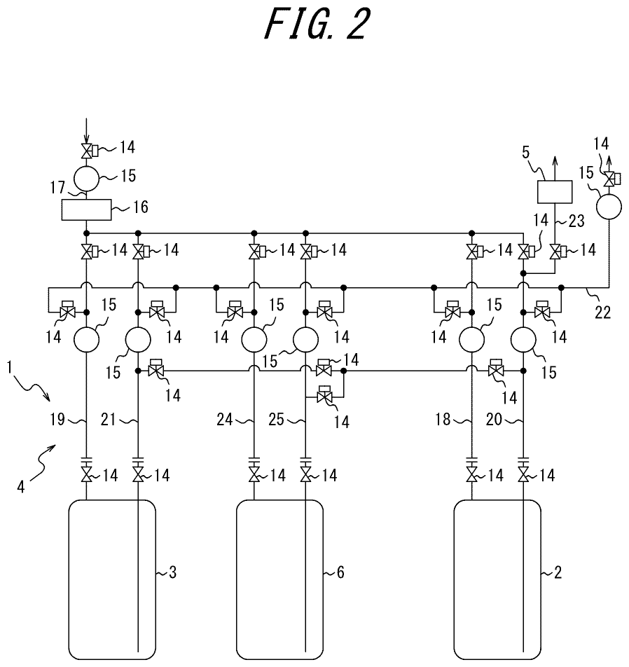

As in the second embodiment illustrated in FIG. 2, a configuration may be adopted in which the storage device 1 includes an acid/alkaline solution tank 6 for storing an acid/alkaline solution that is an acidic or alkaline solution, and the channel section 4 can supply an inert gas to the acid/alkaline solution tank 6, can supply the acid/alkaline solution from the acid/alkaline solution tank 6 to the storage tank 2 by supplying the inert gas to the acid/alkaline solution tank 6 and discharging gas from the storage tank 2, and can discharge the acid/alkaline solution from the storage tank 2 by supplying an inert gas to the storage tank 2.

According to the above configuration, an acid/alkaline solution cleaning process can be performed wherein after the completion of the solvent treatment process, an inert gas is supplied to the acid/alkaline solution tank 6 (for example, pressurized at 0.1 MPaG or more) and gas is discharged from the storage tank 2, thereby supplying the acid/alkaline solution from the acid/alkaline solution tank 6 to the storage tank 2 and dissolving the residue of the storage material remaining in the storage tank 2 into the acid/alkaline solution, and wherein an inert gas is supplied to the storage tank 2 (for example, pressurized at 0.1 MPaG or more), thereby discharging the acid/alkaline solution from the storage tank 2.

As illustrated in FIG. 2, the channel section 4 may be configured to supply an inert gas into the acid/alkaline solution inside the storage tank 2. According to the above configuration, by supplying a predetermined amount of inert gas (for example, 0.1 slm to 50 slm) into the acid/alkaline solution in the storage tank 2 and bubbling for a predetermined time (for example, 1 minute or more) in the acid/alkaline solution cleaning process, the cleaning effect of the acid/alkaline solution can be enhanced.

The acid/alkaline solution is an acidic solution containing nitric acid, citric acid, or hydrofluoric acid, or an alkaline solution containing ammonia water. According to the above configuration, a stable cleaning effect can be obtained using the acid/alkaline solution. The preferred concentration of the acidic solution is: nitric acid: 1% to 55%, citric acid: 1% to 30%, hydrofluoric acid: 0.1% to 5%. The concentration of the preferred alkaline solution is ammonia water: 1% to 30%.

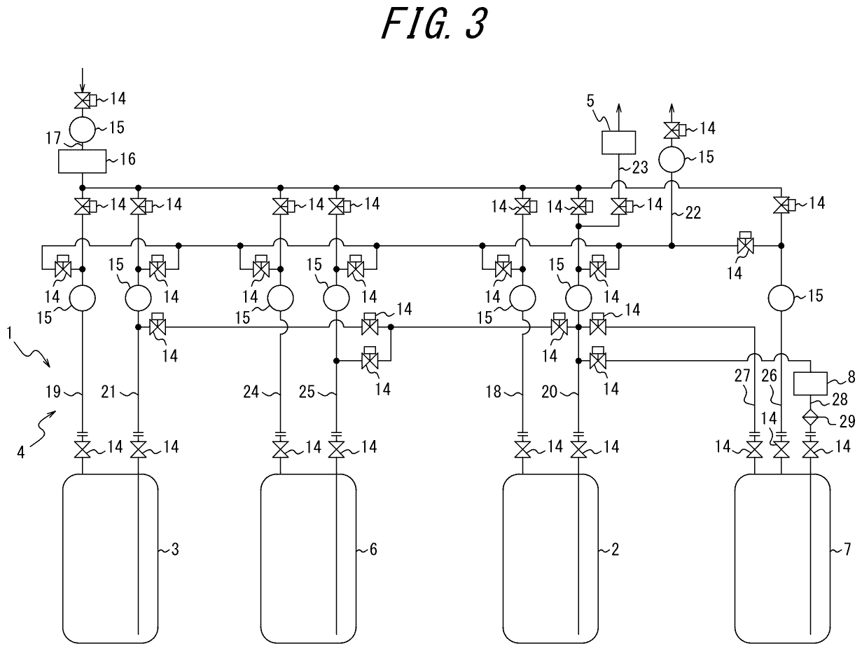

As in the third embodiment illustrated in FIG. 3, a configuration may be adopted in which the storage device 1 includes a reuse tank 7 that stores the acid/alkaline solution, and the channel section 4 can discharge gas from the reuse tank 7, can supply the acid/alkaline solution from the storage tank 2 to the reuse tank 7 by supplying an inert gas to the storage tank 2 and discharging gas from the reuse tank 7, and can supply the acid/alkaline solution from the reuse tank 7 to the storage tank 2 by supplying an inert gas to the reuse tank 7 and discharging gas from the storage tank 2.

According to the above configuration, after the acid/alkaline solution cleaning process, an inert gas is supplied to the storage tank 2 (for example, pressurized at 0.1 MPaG or more) and gas is discharged gas from the reuse tank 7, so that the acid/alkaline solution can be supplied from the storage tank 2 to the reuse tank 7 and stored. Alternatively, instead of performing the acid/alkaline solution cleaning process next, an acid/alkaline solution reuse cleaning process can be performed wherein an inert gas is supplied to the reuse tank 7 (for example, pressurized at 0.1 MPaG or more) and gas is discharged from the storage tank 2, thereby supplying the acid/alkaline solution from the reuse tank 7 to the storage tank 2. Thus, according to the above configuration, the acid/alkaline solution can be reused.

As illustrated in FIG. 3, the storage device 1 may be configured to include a pH detector 8 on the channel for supplying the acid/alkaline solution from the reuse tank 7 to the storage tank 2, and the channel section 4 may be able to select whether to supply the acid/alkaline solution to the storage tank 2 based on the detection result of the pH detector 8 (for example, to discard the acid/alkaline solution rather than supplying it to the storage tank 2 and instead supply an acid/alkaline solution from the acid/alkaline solution tank 6 to the storage tank 2). This configuration makes it possible to avoid reusing an acid/alkaline solution that has become contaminated to an inappropriate level for reuse.

The channel section 4 may also be configured to supply an acidic solution to the storage tank 2. According to the above configuration, after the acid/alkaline solution cleaning process (or the acid/alkaline solution reuse cleaning process), a passivation treatment process can be performed wherein gas is discharged from the storage tank 2, an acidic solution is supplied to the storage tank 2, and the acidic solution is held in the storage tank 2 for a predetermined time (for example, 1 minute or more) to passivate the inner surface of the storage tank 2. By the passivation treatment, the corrosion of the storage tank 2 can be suppressed. In this case, the configuration of the storage device 1 can be simplified by using an acidic solution suitable for passivation treatment as the acid/alkaline solution stored in the acid/alkaline solution tank 6.

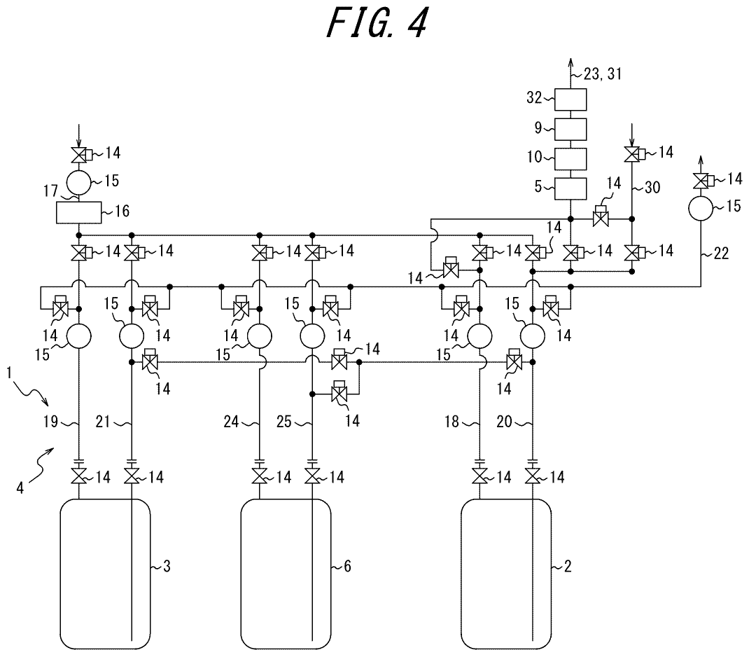

As illustrated in the fourth embodiment in FIG. 4, a configuration may be adopted in which the channel section 4 can supply deionized water to the storage tank 2 and can discharge the deionized water from the storage tank 2.

According to the above configuration, after the acid/alkaline solution cleaning process (after the acid/alkaline solution cleaning process or the acid/alkaline solution reuse cleaning process in a case of combination with the configuration of the third embodiment to enable performance of the acid/alkaline solution reuse cleaning process), or after the passivation treatment process, or alternatively after the solvent treatment process in a case in which the acid/alkaline solution cleaning process (or the acid/alkaline solution reuse cleaning process) is not performed (the above configuration may be combined with a configuration that does not perform the acid/alkaline solution cleaning process, as in the first embodiment), a deionized water treatment process can be performed, wherein deionized water is supplied to the storage tank 2, the residue of the storage material remaining in the storage tank 2 is dissolved into the deionized water, and the deionized water is discharged from the storage tank 2.

As illustrated in FIG. 4, the storage device 1 may be configured to include a resistivity detector 9 that detects the resistivity of the deionized water supplied to the storage tank 2. According to the above configuration, the deionized water treatment process can be terminated based on the detection result of the resistivity detector 9. The resistivity detector 9 is configured by, for example, a resistivity meter. In this case, for example, deionized water of 18 MΩ·cm or less is used, and the deionized water treatment process can be terminated when the detection result is, for example, 15 MΩ·cm or more. The resistivity detector 9 can, for example, be provided on the channel for discharging deionized water from the storage tank. Instead of the resistivity detector 9, a conductivity detector that detects the conductivity of the deionized water supplied to the storage tank 2 may be provided. The conductivity detector is, for example, configured by a conductivity meter.

As illustrated in FIG. 4, a configuration may be adopted in which the channel section 4 can circulate deionized water to the storage tank 2 (for example, at 0.1 L/min to 10 L/min for 60 min or more). According to the above configuration, the deionized water treatment process can be performed efficiently.

As illustrated in FIG. 4, the storage device 1 may be configured to include a detector 10 of storage material in deionized water. The detector 10 detects the storage material in the deionized water supplied to the storage tank 2. According to the above configuration, the deionized water treatment process can be terminated based on the detection result of the detector 10 of storage material in deionized water. The detector 10 of storage material in deionized water is configured by, for example, a liquid particle counter. In this case, the deionized water treatment process can be terminated when the detection result is, for example, 10 particles/L or less. The detector 10 of storage material in deionized water can, for example, be provided on the channel for discharging the deionized water from the storage tank.

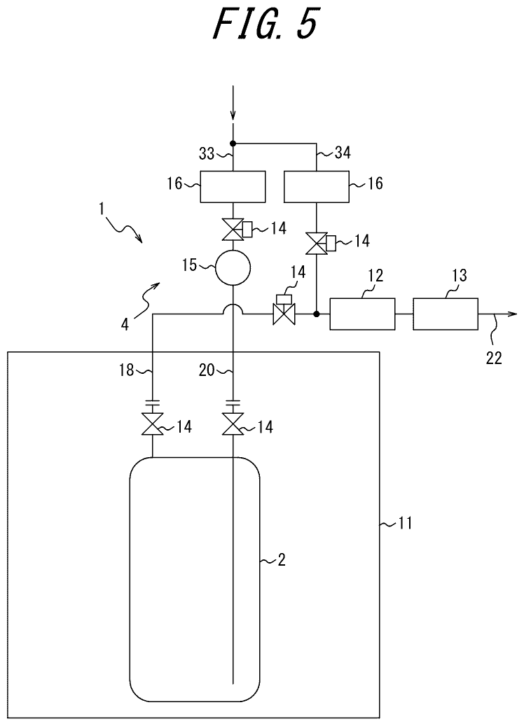

A configuration may be adopted where the storage device 1, as illustrated in FIG. 5, includes a heater 11 that can heat the storage tank 2, and the channel section 4 can dry the storage tank 2 by supplying an inert gas to the storage tank 2 after the temperature of the storage tank 2 has been raised by the heater 11 (fifth embodiment). According to the above configuration, after the solvent treatment process, the acid/alkaline solution cleaning process (or acid/alkaline solution reuse cleaning process), the passivation treatment process, or the deionized water treatment process, a drying process can be performed by supplying an inert gas to the storage tank 2 after the temperature of the storage tank 2 has been raised by the heater 11. Therefore, according to the above configuration, more precise removal of residue in the storage tank 2 can be achieved.

The fifth embodiment can be configured in combination with any of the first to fourth embodiments described above. The heater 11 may be pre-installed with respect to the storage tank 2, or a configuration may be adopted in which the heater 11 is installed in another location, and the storage tank 2 is moved to the heater 11 at an appropriate timing. The heater 11 is, for example, configured by a constant temperature bath.

The drying process can be performed under conditions such that the flow rate of the inert gas is 0.1 slm to 10 slm, the processing time is 60 min or more, and the temperature inside the storage tank 2 is from room temperature to 150° C.

As illustrated in FIG. 5, the storage device 1 may be configured to include a dew point detector 12 that detects the dew point of the inert gas supplied to the storage tank 2. According to the above configuration, by detecting the dew point of the inert gas supplied to the storage tank 2 with the dew point detector 12, it is possible to determine, for example by comparing the detected value with a threshold, whether the drying state of the storage tank 2 is sufficient to terminate the drying process. The termination of the drying process can, for example, be determined by whether the dew point has reached −76° C. or lower. The dew point detector 12 is, for example, configured by a dew point meter. The dew point detector 12 can, for example, be provided on the channel for discharging the inert gas from the storage tank.

As illustrated in FIG. 5, the storage device 1 may be configured to include a detector 13 of storage material in the inert gas. The detector 13 detects the storage material in the inert gas supplied to the storage tank 2. According to the above configuration, the drying process can be terminated based on the detection results of the detector 13 of storage material in the inert gas. The detector 13 of storage material in the inert gas is, for example, configured by an air particle counter. In this case, the drying process can be terminated when the detection result is, for example, 10 particles/L or less. The detector 13 of storage material in the inert gas can, for example, be provided on the channel for discharging the inert gas from the storage tank.

The storage material is, for example, an organic or inorganic metal compound that is in a liquid or solid state at 25° C. and 1 atmosphere. According to the above configuration, the residue in the storage tank 2 can be stably and precisely removed.

The solvent is, for example, an organic compound (organic solvent). According to the above configuration, the residue in the storage tank 2 can be stably and precisely removed. The organic solvent, which may be any of various process gases, is not particularly limited and can be a solvent that is widely used industrially. Examples include organic solvents such as octane, and fluorocarbon-based or chlorine-based organic solvents. The organic solvent is generally liquid at room temperature (20° C. to 30° C.) and normal pressure (0.1 MPa), but in the present application, the organic solvent may also be a liquefied solvent under pressurized or low-temperature conditions. The organic solvent may, for example, be a saturated hydrocarbon (such as n-hexane or n-octane), a cyclic saturated hydrocarbon (such as cyclohexane), a ketone (such as acetone), an ester (such as ethyl acetate), an aromatic compound (such as benzene or toluene), a cyclic ether compounds (such as tetrahydrofuran: THF), a heterocyclic compound (such as pyridine or piperidine), acetic acid, a chlorinated hydrocarbon (such as dichloromethane or chloroform), an amine compound (such as triethylamine or ethylenediamine), or alcohol (such as methanol or ethanol).

The detector 5 is, for example, configured by a pH meter, a spectrometer, a colorimeter, an ultrasonic meter, or a mass spectrometer. According to the above configuration, the timing for terminating the repetition of the solvent treatment process can be determined stably and appropriately. In the case of using a pH meter, the repetition of the solvent treatment process can be terminated when the detection result reaches the blank value of the solvent, for example.

The storage device 1 be configured to include a storage material amount detector (not illustrated) that detects the amount of the storage material in the storage tank 2. The storage material amount detector is, for example, configured by a scale that measures the weight of the storage tank 2 while the storage tank 2 is storing the storage material, or a level gauge that measures the liquid level of liquid storage material in the storage tank 2. The level gauge is, for example, configured by a liquid level sensor (proximity sensor) that measures the liquid level in a transparent tube connected to the upper and lower parts of the storage tank 2.

In FIG. 1, the channel section 4 includes an inert gas supply common channel 17 having a valve 14, a pressure gauge 15, and a flow control device 16 (for example, a mass flow controller) in this order from upstream to downstream, a first channel 18 extending from the downstream end of the inert gas supply common channel 17 to the upper part of the storage tank, a second channel 19 extending from the downstream end of the inert gas supply common channel 17 to the upper part of the solvent tank 3, a third channel 20 extending from the lower part of the storage tank 2 to the outside of the storage tank, a fourth channel 21 extending from the lower part of the solvent tank 3 to the outside of the storage tank, an exhaust channel 22 connected to the first channel 18 and the second channel 19, and a drainage channel 23 connected to the third channel 20. The solvent can be supplied to the storage tank through the fourth channel 21 and the third channel 20 from the solvent tank 3 and can be discharged from the storage tank through the third channel 20 and the drainage channel 23.

In FIG. 2, the channel section 4 includes, in addition to the configuration of FIG. 1, a fifth channel 24 extending from the downstream end of the inert gas supply common channel 17 to the upper part of the acid/alkaline solution tank 6, and a sixth channel 25 extending from the lower part of the acid/alkaline solution tank 6 to the outside of the acid/alkaline solution tank 6, with the exhaust channel 22 being connected also to the fifth channel 24. The acid/alkaline solution can be supplied to the storage tank through the sixth channel 25 and the third channel 20 from the acid/alkaline solution tank 6, and can be discharged from the storage tank through the third channel 20 and the drainage channel 23.

In FIG. 3, the channel section 4 includes, in addition to the configuration of FIG. 2, a seventh channel 26 extending from the downstream end of the inert gas supply common channel 17 to the top of the reuse tank 7, an eighth channel 27 extending from the top of the reuse tank 7 to the outside of the reuse tank 7, and a ninth channel 28 extending from the bottom of the reuse tank 7 to the outside of the reuse tank 7, with the exhaust channel 22 also being connected to the seventh channel 26, and the ninth channel 28 including a liquid filter 29 and a pH detector 8. The acid/alkaline solution can be supplied from the storage tank to the reuse tank 7 through the third channel 20 and the eighth channel 27. Also, the acid/alkaline solution can be supplied from the reuse tank 7 to the storage tank through the ninth channel 28 and the third channel 20, and if the acid/alkaline solution is contaminated to an unsuitable level for reuse, it can be discharged from the reuse tank 7 through the ninth channel 28 and the drainage channel 23.

In FIG. 4, the channel section 4 includes a deionized water supply channel 30 that can supply deionized water to the third channel 20, and a deionized water discharge channel 31 that is connected to the first channel 18 and can discharge the deionized water. The deionized water discharge channel 31 includes the detector 5, the detector 10 of storage material in deionized water, the resistivity detector 9, and a flow meter 32.

In FIG. 5, the channel section 4 includes an inert gas supply first channel 33 connected to the third channel 20 and an inert gas supply second channel 34 connected to the exhaust channel 22. The inert gas supply first channel 33 includes a flow control device 16, a valve 14, and a pressure gauge 15 in this order from upstream to downstream. The inert gas supply second channel 34 includes a flow control device 16 and a valve 14 in this order from upstream to downstream. The exhaust channel 22 includes the dew point detector 12 and an inert gas storage material detector 13. The inert gas can flow in the order of the inert gas supply first channel 33, the third channel 20, inside the storage tank 2, the second channel 19, and the exhaust channel 22. The inert gas can be appropriately supplied from the inert gas supply second channel 34 to the exhaust channel 22.

The present disclosure is not limited to the above embodiments and can be modified in various ways without departing from the scope thereof.

### EXAMPLES

### Comparative Example 1

As Comparative Example 1, an experiment was conducted using the following storage material and solvent.
Storage material (water-reactive liquid): Bis(diethylamino)silane (storage tank capacity: 1 L)
Solvent: n-hexane
[Experimental method] The storage tank was opened in a draft and rinsed with n-hexane.
[Experimental conditions] Solvent treatment in open air
[Experimental results] Even at the 10^{th} washing with solvent, the pH exceeded the full scale of 20 and did not reach the blank value for n-hexane of pH=5. In addition, solid matter believed to be hydrolysis products of bis(diethylamino)silane was adhered to the inside of the storage tank.

### Example 1

As Example 1, an experiment was conducted using the following storage material, solvent, and acidic solution.
Storage material (water-reactive liquid): Bis(diethylamino)silane (storage tank capacity: 1 L)
Solvent: n-hexane
Acidic solution: 25% citric acid

### [Experiment 1-1: Solvent Treatment Process]

[Experimental method] In the storage device illustrated in FIG. 1, a storage tank with a capacity of 1 L was filled with bis(diethylamino)amine, and after discharging, a solvent treatment process using the solvent (n-hexane) was carried out.

[Experimental conditions] Inert gas for pumping: N₂, pumping pressure: 0.1 MPaG, holding time: 1 minute

[Experimental results] The blank value of the solvent was reached in the third solvent treatment process. Specifically, for n-hexane with a pH of 5.0, the measured pH was over 20 after the first treatment, 8.3 after the second treatment, and 5.3 after the third treatment.

Experiment 1-2 was conducted after Experiment 1-1.

### [Experiment 1-2: Acid/Alkaline Solution Cleaning Process, Passivation Treatment Process]

[Experimental method] After the solvent treatment process, an acidic solution (25% citric acid) was used for the acid/alkaline solution cleaning process (with bubbling), followed by the passivation treatment process.

[Experimental conditions] (1) Bubbling conditions after introducing 25% citric acid
Inert gas: N₂, gas flow rate: 10 slm, pumping pressure: 0.1 MPaG, Bubbling time: 5 minutes
(2) Passivation treatment conditions with 25% citric acid
Holding time after introducing 25% citric acid: 1 hour

[Experimental Results] No reactive residues were confirmed in the storage tank. The results of surface composition analysis by X-ray photoelectron spectroscopy (XPS) before and after treatment are illustrated. A chromium oxide-rich passivation film was observed after the passivation treatment process.

TABLE 1

| | |
|---|---|
| SiO₂ equivalent | CrOx element concentration (atomic %) |

| depth (nm) | Before acid treatment | After acid treatment |
|---|---|---|
| 0 | 2.5 | 7.5 |
| 1 | 8.3 | 17.5 |
| 2 | 10 | 11.7 |

Experiment 1-3 was conducted after Experiments 1-1 and 1-2.

### [Experiment 1-3: Deionized Water Treatment Process (Circulation)]

[Experimental method]A deionized water treatment process (circulation) was conducted after the passivation treatment process.

[Experimental conditions] Deionized water: 18 MΩ·cm, flow rate: 0.5 L/min, pressure: atmospheric pressure

[Experimental results] The results of analyzing the resistivity and metal impurity concentration (measurement method: inductively coupled plasma mass spectrometry, ICP-MS) before and after treatment are illustrated. After 5 hours of water treatment, the resistivity reached the level of deionized water (which is ≥15 MΩ·cm), and no contamination in the storage tank due to metal impurities was confirmed. In addition, the number of particles of 0.1 μm or more in the liquid was 5 particles/L.

| | |
|---|---|
| Resistivity (MΩ · cm) | before treatment: 0.01 |
| | after treatment (5 hours): 17 |

TABLE 2

| Metal | Before treatment | After treatment (5 hours) |
|---|---|---|
| impurity | (wt · ppb) | (wt · ppb) |
| Na | 0.04 | 0.08 |
| Ca | 0.28 | <0.03 |
| Cr | 0.02 | <0.01 |
| Mn | 0.66 | 0.01 |
| Fe | 1.4 | <0.02 |
| Ni | 2.5 | 0.18 |

Experiment 1-4 was conducted after Experiments 1-1, 1-2, and 1-3.

### [Experiment 1-4: Drying Process]

[Experimental method]A drying process was conducted after the deionized water treatment process (circulation).

[Experimental conditions] Inert gas: N₂, gas flow rate: 10 slm, pumping pressure: 0.1 MPaG

[Experimental results] The results of the analysis of the dew point before and after drying are illustrated. The dew point reached −80° C. after 3 hours of drying. In addition, the number of particles of 0.1 μm or more in the gas was 1 particle/L.

| | |
|---|---|
| Dew point | 1 hour after drying: −30° C. |
| | 3 hours after drying: −80° C. |

### Comparative Example 2

As Comparative Example 2, an experiment was conducted using the following storage material and solvent.
Storage material (corrosive solid): Molybdenum (VI) dichloride dioxide (storage tank capacity: 1 L)
Solvent: Tetrahydrofuran

[Experimental method] The storage tank was opened in a draft and rinsed with tetrahydrofuran. Subsequently, water treatment was performed in the storage tank using deionized water at 18 MΩ·cm.

[Experimental conditions] Solvent treatment in open air Deionized water: 18 MΩ·cm, flow rate: 0.5 L/min, pressure: atmospheric pressure

[Experimental results] Even at the 10^{th} washing with the solvent, the pH was 4.2, which did not reach the blank value of pH=8.1 for tetrahydrofuran. In addition, solid matter believed to be hydrolysis products of molybdenum (VI) dichloride dioxide was adhered to the inside of the storage tank. The solid matter could not be removed even in the subsequent process of passing deionized water, and the resistivity after 24 hours was 1 MΩ·cm.

### Example 2

As Example 2, an experiment was conducted using the following storage material, solvent, and acidic solution.
Corrosive solid material: Molybdenum (VI) dichloride dioxide (storage tank capacity: 1 L)
Solvent: Tetrahydrofuran

### [Experiment 2-1: Solvent Treatment Process]

[Experimental Method] In the storage device illustrated in FIG. 1, a storage tank with a capacity of 1 L was filled with molybdenum (VI) dichloride dioxide, and after discharging, a solvent treatment process using the solvent (tetrahydrofuran) was carried out.

[Experimental conditions] Inert gas for pumping: N₂, pumping pressure: 0.1 MPaG, holding time: 1 minute

[Experimental results] The blank value of the solvent was reached in the third solvent treatment process. Specifically, for tetrahydrofuran with a pH of 8.1, the measured pH was 0.4 after the first treatment, 6.9 after the second treatment, and 8.0 after the third treatment.

Experiment 2-2 was conducted after Experiment 2-1.

### [Experiment 2-2: Deionized Water Treatment Process (Circulation)]

[Experimental method]A deionized water treatment process (circulation) was conducted after the solvent treatment process.

[Experimental conditions] Deionized water: 18 MΩ·cm, flow rate: 0.5 L/min, pressure: atmospheric pressure

[Experimental results] The results of analyzing the resistivity and metal impurity concentration (measurement method: inductively coupled plasma mass spectrometry, ICP-MS) before and after treatment are illustrated. After 5 hours of treatment, the resistivity reached the level of deionized water (which is ≥15 MΩ·cm), and no contamination in the storage tank due to metal impurities was confirmed. In addition, the number of particles of 0.1 μm or more in the liquid was 3 particles/L.

| | |
|---|---|
| Resistivity (MΩ · cm) | before treatment: 0.01 |
| | after treatment (5 hours): 17 |

TABLE 3

| Metal | Before treatment | After treatment (5 hours) |
|---|---|---|
| impurity | (wt · ppb) | (wt · ppb) |
| Na | 1.0 | <0.1 |
| Ca | 2.9 | 0.1 |
| Cr | 0.1 | <0.1 |
| Mn | 0.3 | <0.1 |
| Fe | 0.2 | 0.4 |
| Ni | 0.3 | <0.1 |
| Mo | 5.0 | 0.3 |

Experiment 2-3 was conducted after Experiments 2-1 and 2-2.

### [Experiment 2-3: Drying Process]

[Experimental method]A drying process was conducted after the deionized water treatment process (circulation).

[Experimental conditions] Inert gas: N₂, gas flow rate: 10 slm, pressure: 0.1 MPaG

[Experimental results] The results of the analysis of the dew point before and after drying are illustrated. The dew point reached −80° C. after 3 hours of drying. In addition, the number of particles of 0.1 μm or more in the gas was 1 particle/L.

| | |
|---|---|
| Dew point | 1 hour after drying: −33° C. |
| | 3 hours after drying: −80° C. |

### REFERENCE SIGNS LIST

1 Storage device
2 Storage tank
3 Solvent tank
4 Channel section
5 Detector
6 Acid-alkali solution tank
7 Reuse tank
8 pH detector
9 Resistivity detector
10 Detector of storage material in deionized water
11 Heater
12 Dew point detector
13 Detector of storage material in inert gas
14 Valve
15 Pressure gauge
16 Flow control device
17 Inert gas supply common channel
18 First channel
19 Second channel
20 Third channel
21 Fourth channel
22 Exhaust channel
23 Drainage channel
24 Fifth channel
25 Sixth channel
26 Seventh channel
27 Eighth channel
28 Ninth channel
29 Liquid filter
30 Deionized water supply channel
31 Deionized water discharge channel
32 Flow meter
33 Inert gas supply first channel
34 Inert gas supply second channel

1. A storage device comprising:
a storage tank configured to store a liquid or solid storage material;
a solvent tank configured to store a solvent;
a channel section that can supply an inert gas to the solvent tank, can discharge gas from the storage tank, can supply the solvent from the solvent tank to the storage tank by supplying the inert gas to the solvent tank and discharging gas from the storage tank, can supply an inert gas to the storage tank, and can discharge the solvent from the storage tank by supplying the inert gas to the storage tank; and
a detector configured to detect the storage material in the solvent supplied to the storage tank.

2. The storage device according to claim 1, further comprising
an acid/alkaline solution tank configured to store an acid/alkaline solution that is an acidic or alkaline solution, wherein
the channel section can supply an inert gas to the acid/alkaline solution tank, can supply the acid/alkaline solution from the acid/alkaline solution tank to the storage tank by supplying the inert gas to the acid/alkaline solution tank and discharging gas from the storage tank, and can discharge the acid/alkaline solution from the storage tank by supplying an inert gas to the storage tank.

3. The storage device according to claim 2, wherein the channel section can supply an inert gas into the acid/alkaline solution inside the storage tank.

4. The storage device according to claim 2, wherein the acid/alkaline solution is an acidic solution containing nitric acid, citric acid, or hydrofluoric acid, or an alkaline solution containing ammonia water.

5. The storage device according to claim 2, further comprising
a reuse tank configured to store the acid/alkaline solution, wherein
the channel section can discharge gas from the reuse tank, can supply the acid/alkaline solution from the storage tank to the reuse tank by supplying an inert gas to the storage tank and discharging gas from the reuse tank, and can supply the acid/alkaline solution from the reuse tank to the storage tank by supplying an inert gas to the reuse tank and discharging gas from the storage tank.

6. The storage device according to claim 1, wherein the channel section can supply deionized water to the storage tank and can discharge the deionized water from the storage tank.

7. The storage device according to claim 6, wherein the channel section can circulate the deionized water to the storage tank.

8. The storage device according to claim 1, further comprising
a heater configured to heat the storage tank, wherein
the channel section can dry the storage tank by supplying an inert gas to the storage tank after a temperature of the storage tank has been raised by the heater.

9. The storage device according to claim 1, wherein the storage material is an organic or inorganic metal compound that is in a liquid or solid state at 25° C. and 1 atmosphere.

10. The storage device according to claim 1, wherein the solvent is an organic compound.

11. The storage device according to claim 1, wherein the detector is configured by a pH meter, a spectrometer, a colorimeter, an ultrasonic meter, or a mass spectrometer.
